(19) United States
(12) Patent Application Publication
(10) Pub. No.: US 2014/0330813 A1
(43) Pub. Date: Nov. 6, 2014

(54) DISPLAY APPARATUS AND SEARCHING METHOD

(71) Applicant: SAMSUNG ELECTRONICS CO., LTD., Suwon-si (KR)

(72) Inventors: Seung-hwan LEE, Gwangmyeong-si (KR); Soo-yeoun YOON, Seoul (KR)

(73) Assignee: SAMSUNG ELECTRONICS CO., LTD., Suwon-si (KR)

(21) Appl. No.: 14/211,597

(22) Filed: Mar. 14, 2014

(30) Foreign Application Priority Data
May 3, 2013 (KR) 10-2013-0050177

(51) Int. Cl. G06F 17/30

(52) U.S. Cl. CPC G06F 17/30554
USPC 707/722

(57) ABSTRACT

A display apparatus and a searching method are provided. The display apparatus includes: a receiver configured to receive a broadcasting signal; a display configured to display content of the received broadcasting signal; a communicator configured to transmit a first keyword and a content title and receive a first search result performed based on the first keyword and the content title; and a controller configured to extract a plurality of keyword candidates from the search result, display the plurality of keyword candidates on the display, if a second keyword is selected as one of the plurality of keyword candidates either manually or in response to a detected event, to transmit the second keyword through the communicator in order to perform a search for the second keyword.

### CROSS-REFERENCE TO RELATED APPLICATION

This application claims priority from Korean Patent Application No. 10-2013-0050177, filed on May 3, 2013, in the Korean Intellectual Property Office, the disclosure of which is incorporated herein by reference in its entirety.

### BACKGROUND

1. Field

The present exemplary embodiments generally relate to providing a display apparatus and a searching method, and more particularly, to providing a display apparatus that communicates with a search server to perform a search, and a searching method.

2. Description of the Related Art

Various types of display apparatuses including display units, such as Televisions (TVs), portable terminals, or the like, have been used recently. In particular, terminals applying Social Networking Services (SNSs), information providing services, or the like have been provided to the display apparatus. For example, a social TV combining a TV and an SNS has been provided.

One use of a social TV includes sharing opinions through an additional smart phone or Personal Computer (PC) while watching TV. Because an additional terminal is required separate from the TV, and because several networking functions are required to be installed in the TV to make the TV smart, a method of directly sharing information on the TV while watching TV is preferable. By using this method, a user may know information about a broadcast program displayed on the TV through program guide information or the like and may directly obtain others' opinions or information about a program on the TV by using the information about the program as a keyword.

However, according to a related art, only a keyword for identifying a broadcasting channel is provided to an SNS server to request information related to the broadcasting channel. Therefore, it is difficult to search an SNS for detailed information about a broadcast program and other related information.

Further, keywords input by a user are not stored on the SNS, thus making it inconvenient to input the keyword or a search word.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

According to an aspect of the exemplary embodiments, there may be provided a display apparatus including a receiver that receives a broadcasting signal; a display that displays content of the received broadcasting signal; a communicator that transmits a first keyword and a content title and to receives a first search result based on the transmitted first keyword and content title; and a controller that extracts a plurality of keyword candidates from the first search result, displays the plurality of keyword candidates on the display, and if a second keyword is selected as one of the plurality of keyword candidates, transmits the second keyword through the communicator to perform a search for the second keyword.

The controller may control the communicator to automatically extract the first keyword and the content title based on program guide information of the broadcasting signal and to transmit the extracted first keyword and content title.

The controller may control the communicator to display a user interface (UI) screen for receiving the first keyword and the content title through the display and, if the first keyword and the content title are received through the UI screen, to transmit the first keyword and the content title to the search server.

If a second search result of the second keyword is received, the controller may displays a screen comprising the second search result and the content on the display. The screen may include a first area configured to display the content, a second area configured to display the plurality of keyword candidates, a third area configured to display the second keyword selected from the plurality of keyword candidates, a fourth area configured to display information about a search server, and a fifth area configured to display the second search result of the second keyword.

The controller may arrange and display the plurality of keyword candidates in the second area according to a frequency of the plurality of keyword candidates in the first search result.

The controller may arrange and display the plurality of keyword candidates in the second area according to a frequency of the plurality of keyword candidates for which search requests are made.

The first search result may be received from a search server, the search server being a Social Networking Service (SNS) server. The controller may receive a second search result corresponding to the second keyword among SNS information registered in the SNS server and display the second search result through the display.

According to another aspect of the exemplary embodiments, there is provided a search method of a display apparatus, the searching method including receiving a broadcasting signal, transmitting a first keyword and a content title of the received broadcasting signal, if a first search result generated based on the transmitted first keyword and content title is received, extracting a plurality of keyword candidates from the first search result, displaying the plurality of keyword candidates, and if a second keyword is selected as one of the plurality of keyword candidates, transmitting the second keyword in order to perform a second search for the second keyword.

The transmitting of the first keyword and the content title may include automatically extracting the first keyword and the content title based on program guide information of the broadcasting signal, and transmitting the extracted first keyword and content title.

The transmitting of the first keyword and the content title may include displaying a user interface (UI) screen for receiving the first keyword and the content title, and if the first keyword and the content title are input through the UI screen, transmitting the first keyword and the content title.

If a second search result of the second keyword is received, a screen may be displayed including the second search result and the content, wherein the screen may include a first area configured to display the content, a second area configured to display the plurality of keyword candidates, a third area configured to display the second keyword selected from the plurality of keyword candidates, a fourth area configured to display information about a search server, and a fifth area configured to display the second search result of the second keyword.

The plurality of keyword candidates may be arranged and displayed in the second area according to a frequency of the plurality of keyword candidates in the first search result.

The plurality of keyword candidates may be arranged and displayed in the second area according to a frequency of the plurality of keyword candidates for which search requests are made.

The first search result may be received from a search server, the search server being a Social Networking Service (SNS) server, wherein the searching method may include receiving and displaying a second search result corresponding to the second keyword among SNS information registered in the SNS server.

According to an aspect of the exemplary embodiments, there may be provided a display apparatus including a receiver configured to receive a broadcasting signal, a display configured to display content of the received broadcasting signal, a communicator configured to transmit a first keyword and a content title and to receive a first search result based on the first keyword and the content title, and a controller configured to extract a plurality of keyword candidates from the first search result and display the plurality of keyword candidates on the display, to recognize an event and extract a keyword from the plurality of keyword candidates based on the recognized event, to select the extracted keyword as a second keyword, and to transmit the second keyword in order to perform a second search for the second keyword.

The controller may be configured to detect a finger gesture of a user as an event used to indicate the second keyword.

The controller may be configured to detect a palm gesture of a user as an event used to indicate a grab and throw operation.

The controller may be configured to detect audio of a user as an event used to indicate the second keyword.

According to an aspect of the exemplary embodiments, there may be provided a search method of a display apparatus, the searching method including receiving a broadcasting signal, transmitting a first keyword and a content title of the received broadcasting signal, if a first search result generated based on the transmitted first keyword and content title is received, extracting a plurality of keyword candidates from the first search result, displaying the plurality of keyword candidates, recognizing an event corresponding to a selection of a second keyword from among the plurality of keyword candidates, and transmitting the second keyword in order to perform a second search for the second keyword. The recognizing may include detecting a finger gesture of a user as the event corresponding to a selection of a second keyword, detecting a palm gesture of a user as the event used to indicate a grab and throw operation, or detecting audio of a user as the event corresponding to a selection of a second keyword.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a structure of a display system according to an exemplary embodiment;

FIG. 2 is a block diagram illustrating a structure of a content providing system according to an exemplary embodiment;

FIG. 3 is a block diagram illustrating a display apparatus according to an exemplary embodiment;

FIG. 4 is a block diagram synthetically illustrating a structure of a display apparatus according to various exemplary embodiments;

FIG. 5 is a block diagram illustrating a software structure that is used by a display apparatus, according to an exemplary embodiment;

FIG. 6 is a view illustrating a screen structure of a display apparatus according to an exemplary embodiment;

FIG. 7 is a view illustrating a detailed screen displaying a first area of FIG. 6, according to an exemplary embodiment;

FIG. 8 is a view illustrating a detailed screen displaying the first are of FIG. 6, according to an exemplary embodiment;

FIG. 9 is a view illustrating a detailed screen displaying a search area of FIG. 6, according to an exemplary embodiment;

FIG. 10 is a view illustrating a detailed screen displaying the search area of FIG. 6, according to another exemplary embodiment;

FIG. 11 is a view illustrating a detailed screen displaying the search area of FIG. 6, according to another exemplary embodiment;

FIGS. 12A and 12B are views illustrating a process of selecting a keyword according to an exemplary embodiment;

FIGS. 13A and 13B are views illustrating a process of selecting a keyword according to another exemplary embodiment;

FIGS. 14A and 14B are views illustrating a process of selecting a keyword according to another exemplary embodiment;

FIG. 15 is a view illustrating a process of selecting a keyword according to another exemplary embodiment;

FIG. 16 is a view illustrating a detailed screen of a fifth area of FIG. 5, according to an exemplary embodiment;

FIG. 17 is a view illustrating a detailed screen of the search area of FIG. 6, according to another exemplary embodiment; and

FIG. 18 is a flowchart illustrating a searching method according to an exemplary embodiment.

### DETAILED DESCRIPTION

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

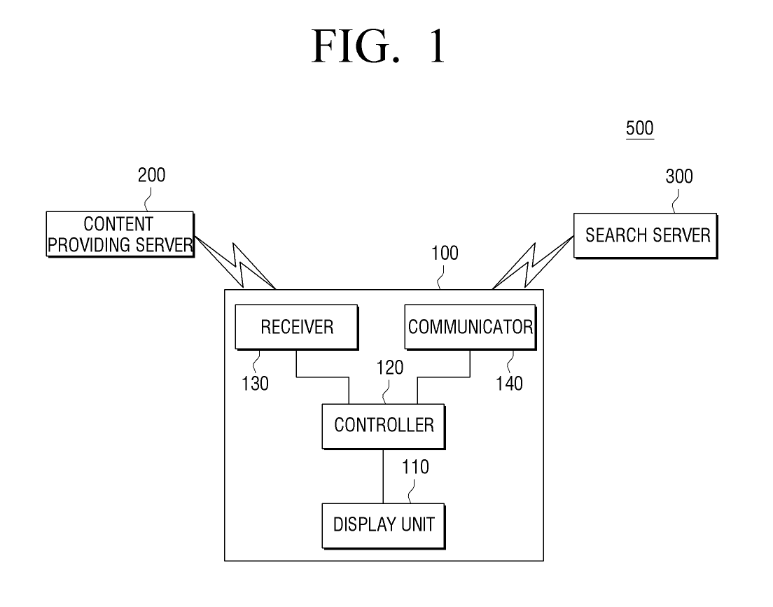

FIG. 1 is a block diagram illustrating a structure of a display system 500 according to an exemplary embodiment.

Referring to FIG. 1, the display system 500 according to the present exemplary embodiment may include a display apparatus 100, a content providing server 200, and a search server 300.

The content providing server 200 transmits content, and the display apparatus 100 receives the content from the content providing server 200. The content may be a broadcasting program such as news, an entertainment program, a drama, or the like that is transmitted from a broadcasting station. The content may also be video, audio, text, an image, or the like that is transmitted and received between persons. In addition, the content may be video, audio, text, an image, or the like that is transmitted through the Internet. A plurality of content providing servers 200 may be provided, and the display apparatus 100 may receive a plurality of content from the plurality of content providing servers 200.

The search server 300 receives a search request from a display apparatus 100 that has received the content, performs a search according to the search request, and transmits a search result to the display apparatus 100. In this case, the display apparatus 100 may request the search server 300 to search for information about received content. The search server 300 may be an SNS server or a web server, and a plurality of search servers 300 may be included and receive the search request from the display apparatus 100. Therefore, the display apparatus 100 may receive a search result from the SNS server and/or the web server.

In one exemplary embodiment, the display apparatus 100 may include a display unit 110, a controller 120, a receiver 130, and a communicator 140.

The receiver 130 receives content from the content providing server 200. In other words, the receiver 130 may receive a content signal through a Radio Frequency (RF) communication network or an Internet Protocol (IP) communication network. If the receiver 130 receives a content signal, the controller 120 controls the display unit 110 to display the content received by the receiver 130.

Here, information about content received by the receiver 130 may be included in the content. The content information may include a content title, a content production date, a content description, etc. The content information may be included in an Electronic Program Guide (EPG), and a user may check the content information through a EPG of the apparatus 100.

Words included in content information or a combination of words may be referred to as a keyword. A keyword included in content information may be referred to as a first keyword. Therefore, the controller 120 may extract the content title and the first keyword. The content title and the first keyword may be automatically extracted by the controller 120 or may be input (e.g., manually) according to a selection by a user. This extraction method will be described in more detail later with reference to the attached drawings.

The display unit 110 displays content received by the receiver 130. In this case, the content displayed by the display unit 110 may be a video, a still image, a text, or the like. The display apparatus 100 may further include a speaker to output audio of the content received by the receiver 130.

If there is a search request from the controller 120, the communicator 140 transmits a signal requesting a search to the search server 300. If the search server 300 performs the search and transmits the search result to the communicator 140, the communicator 140 is controlled by the controller 120 to transmit the search result to the display unit 110.

Here, the communicator 140 may transmit the content title and the first keyword to the search server 300. The first keyword is as described above, and the search server 300 may perform the search based on the content title and the first keyword. In this case, the search server 300 may perform an AND combination with respect to the content title and the first keyword and transmit a first search result acquired by the AND combination to the communicator 140. According to exemplary embodiments, the first search result may be displayed on a screen or may be used only to extract a keyword candidate without any additional display.

If the first search result is received through the communicator 140, the controller 120 extracts a keyword candidate from the first search result. In other words, the first search result includes a plurality of words including the content title and the first keyword. The controller 120 may determine the keyword candidate from other words of the first search result except the content title and the first keyword. In detail, the controller 120 may determine inclusion frequencies of words of the first search result to automatically extract a plurality of keyword candidates in order of frequency. The controller 120 may control the display unit 110 to display the extracted plurality of keyword candidates.

The user may select one of the displayed keyword candidates and refer to the one keyword selected from the keyword candidates by the user as a second keyword. The second keyword may be transmitted to the communicator 140 under control of the controller 120, and the communicator 140 may transmit the second keyword to the search server 300.

A search server 300 having received a second keyword may perform a search for the second keyword and transmit a second search result of the second keyword to the communicator 140. If the communicator 140 receives the second search result, the controller 120 may control the display unit 110 to display the second search result.

If the search server 300 is an SNS server, the controller 120 may receive the first search result of the first keyword and the second search result of the second keyword among SNS information registered (e.g., stored) in the SNS server and display the first and second search results through the display unit 110. If the search server 300 is a web server, the controller 120 may receive the first search result of the first keyword and the second search result of the second keyword among information in the web server and display the first and second search results through the display unit 110.

Therefore, the display apparatus 100 according to the present exemplary embodiment may provide the first keyword of the content, the content title, and the second search result of the second keyword. Therefore, the user may be presented with detailed and widely-known information about the content.

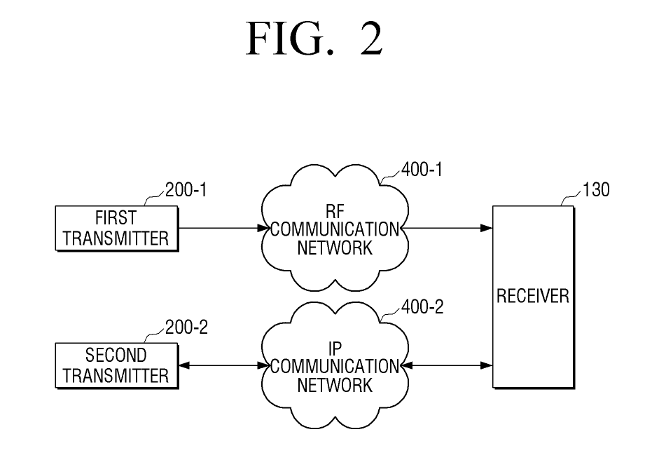

FIG. 2 is a block diagram illustrating a structure of a service providing system according to an exemplary embodiment. Referring to FIG. 2, a service providing system may include a plurality of transmitters 200-1 and 200-2 and a receiver 130. Only one receiver 130 is illustrated in FIG. 2, but a plurality of receivers 130 may be provided.

The plurality of transmitters 200-1 and 200-2 transmit signals through different communication networks. In FIG. 2, the first transmitter 200-1 transmits signals through an RF communication network 400-1, and the second transmitter 200-2 transmits signals through an IP communication network 400-2. However, types of communication networks are not limited thereto. For convenience, in the present exemplary embodiments, a signal transmitted from the first transmitter 200-1 is referred to as a first signal, and a signal transmitted from the second transmitter 200-2 is referred to as a second signal.

The first and second signals may respectively include data that is classified to form contents. For example, video data of 3D content may be divided into left and right eye image data. In this case, one of the left and right eye image data may be included in the first signal and then transmitted through an RF communication network, and the other one of the left and right eye image data may be included in the second signal and the transmitted through an IP communication network.

Content may be divided into video data and audio data or may be divided into moving picture data and subtitle data according to various standards and then transmitted as first and second signals. For convenience, data included in a first signal is defined as reference data, and data included in a second signal is defined as additional data.

A method and a structure for transmitting a signal through the RF communication network 400-1 may be alternatively realized according to broadcasting standards. Examples of digital broadcasting standards include Advanced Television System Committee (ATSC), Digital Video Broadcasting (DVB), and Integrated Services Digital Broadcasting-Terrestrial (ISDB-T) methods, etc.

A detailed structure and operation of the first transmitter 200-1 that transmits the first signal through the RF communication network 400-1 may be different according to which one of the above-mentioned broadcasting standards has been applied. A structure and an operation of the receiver 130 are like the structure and operation of the first transmitter 200-1 described above. For example, if the ATSC standard is applied, the first transmitter 200-1 may include a randomizer, an RS encoder, a data interleaver, a trellis encoder, a sync and pilot inserter, a 8VSB modulator, an RF upconverter, an antenna, etc. The receiver 130 may include an antenna, an RF downconverter, a demodulator, an equalizer, a demultiplexer, an RS decoder, a deinterleaver, etc. Detailed structures for transmitting and receiving signals according to broadcasting standards are disclosed in standard documents of the broadcasting standards in detail, and thus their detailed illustrations and descriptions are omitted herein.

The first signal transmitted from the first transmitter 200-1 may include reference data of data that is divided to form content as described above.

The first signal may further include an information descriptor and additional data reference information besides the reference data. The information descriptor may refer to information that describes a service characteristic provided by the first transmitter 200-1. In detail, a general service may be provided to allow the first transmitter 200-1 to transmit a 2-dimension (2D) or 3D content to the receiver 130 by itself. Also, a hybrid service may be provided to allow the first transmitter 200-1 to divide one content and then transmit the divided content with the second transmitter 200-2, and allow the receiver 130 to combine and play the content. The first transmitter 200-1 may set differently and transmit an information descriptor value according to a type of a service provided. The information descriptor may be recorded and provided in various areas, such as a Terrestrial Virtual Channel Table (TVCT), an Event Information Table (EIT), a Program Map Table (PMT), etc., in a first signal.

The additional data reference information may be information which is referenced in receiving the second signal separately from the first signal and processing the second signal along with the first signal. The additional data reference information may be included in the first signal only when the information descriptor designates a hybrid service, but is not limited thereto. In other words, according to one exemplary embodiment of the present general inventive concept, the additional data reference information may be included in the first signal and may only be realized as being referred to by the receiver 130 when the information descriptor designates a hybrid service. The additional data reference information may be provided to the receiver 130 according to various methods. For example, the additional data reference information may be provided to the receiver 130 through a VCT of a Program and System Information Protocol (PSIP) of the first signal, an EIT, a PMT of program designation information, a metadata stream, or the like.

The second transmitter 200-2 transmits a second signal including additional data to the receiver 130 through the IP communication network 400-2. The IP communication network 400-2 may be realized as various types of networks such as a cloud network, a local network, etc. The second transmitter 200-2 may transmit the second signal using a streaming method. For example, various streaming methods, such as a Real Time Protocol (RTP), a Hypertext Transfer Protocol (HTTP), etc., may be used. According to one exemplary embodiment, the second transmitter 200-2 may provide the additional data by using a download method. According to the download method, a file format may be various types of formats such as AVI, MP4, MPG, MOV, WMV, etc.

The receiver 130 may be realized as various types of apparatuses such as a broadcasting receiving apparatus such as a set-top box, a TV, a portable phone, a Personal Digital Assistant (PDA), a set-top PC, a PC, a notebook PC, a kiosk PC, etc. If the first signal is received from the first transmitter 200-1, the receiver 130 detects and checks the information descriptor from the first signal. If a general service is determined according to a check result, the receiver 130 decodes video data, audio data, and other types of data included in the first signal and outputs the decoded video, the decoded audio data, and the decoded other types of data through a screen and a speaker.

If a hybrid service is determined according to a check result, the receiver 130 detects the additional data reference information from the first signal. The additional data reference information may include at least one or more of various types of information such as broadcasting service type information, additional image type information, approach information about additional data, additional image start time information, synchronization information, etc. The receiver 130 may access the second transmitter 200-2 using the approach information. The receiver 130 may request the second transmitter 200-2 to transmit the additional data. The second transmitter 200-2 may transmit the second signal including the additional data in response to the request for the transmission of the additional data as described above.

The receiver 130 synchronizes the reference data of the first signal with the additional data of the second signal using the synchronization information of the additional data reference information. Various types of information may be used as the synchronization information. In detail, various types of information, such as a time code, a frame index, content start information, a time stamp difference value, UTC information, frame count information, etc., may be used as the synchronization information.

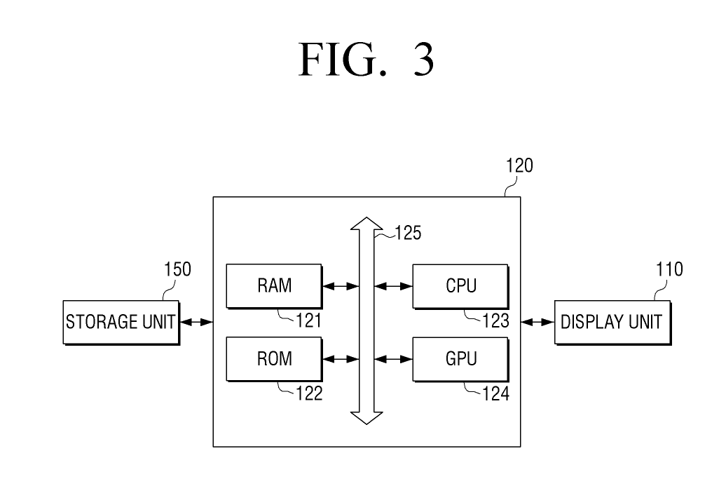

FIG. 3 is a block diagram illustrating the display apparatus 100, according to an exemplary embodiment.

Referring to FIG. 3, display apparatus 100 may include display unit 110, controller 120, and storage unit 150.

The storage unit 150 may store various types of programs and data necessary for operating display apparatus 100.

The controller 120 controls an overall operation of the display apparatus 100 using various types of programs and data stored in storage unit 150. The controller 120 may include a Random Access Memory (RAM) 121, a Read Only Memory (ROM) 122, a Central Processing Unit (CPU) 123, a Graphic Processing Unit (CPU) 124, and a bus 125. The RAM 121, the ROM 122, the CPU 123, the GPU 124, etc. may be connected to one another through a bus 125.

The CPU 123 accesses the storage unit 150 to perform a boot operation using an Operating System (0/S) stored in the storage unit 150. The CPU 123 performs operations using various types of programs, contents, data, etc. stored in the storage unit 150.

The ROM 122 may store a command set, etc. for booting a system. If power is supplied through an input of a turn-on command, the CPU 123 copies an 0/S stored in storage unit 150 into the RAM 121 according to a command stored in the ROM 122, and executes the O/S to boot the system. If the system is completely booted, the CPU 123 copies the various types of programs stored in the storage unit 150 into the RAM 121 and executes the programs copied into the RAM 121 to perform various operations

If a boot process of the display apparatus 100 has completed, the GPU 124 may display a content screen, a search result screen, or the like. For example, the GPU 124 may generate a screen including various types of objects, such as an icon, an image, a text, etc., by using an operator (not shown) and a renderer (not shown). An operator may calculate attribute values, such as coordinate values, for displaying objects, shapes, sizes, and colors of the objects, etc., according to a layout of a screen. The renderer may generate various layouts of screens including objects based on attribute values calculated by an operator. A screen generated by the render may be provided to the display unit 110 to be displayed in a display area.

The display unit 110 may display various types of screens a described above. The display unit 110 may be realized as various types of displays such as a liquid crystal display (LCD), an Organic Light-Emitting Diode (OLED) display, a Plasma Display Panel (PDP), etc. The display unit 110 may further include a driving circuit such as an Amorphous Silicon (a-Si) Thin Film Transistor (TFT), a Low Temperature Poly Silicon (LTPS) TFT, an Organic TFT (OTFT), or the like, a backlight unit, etc.

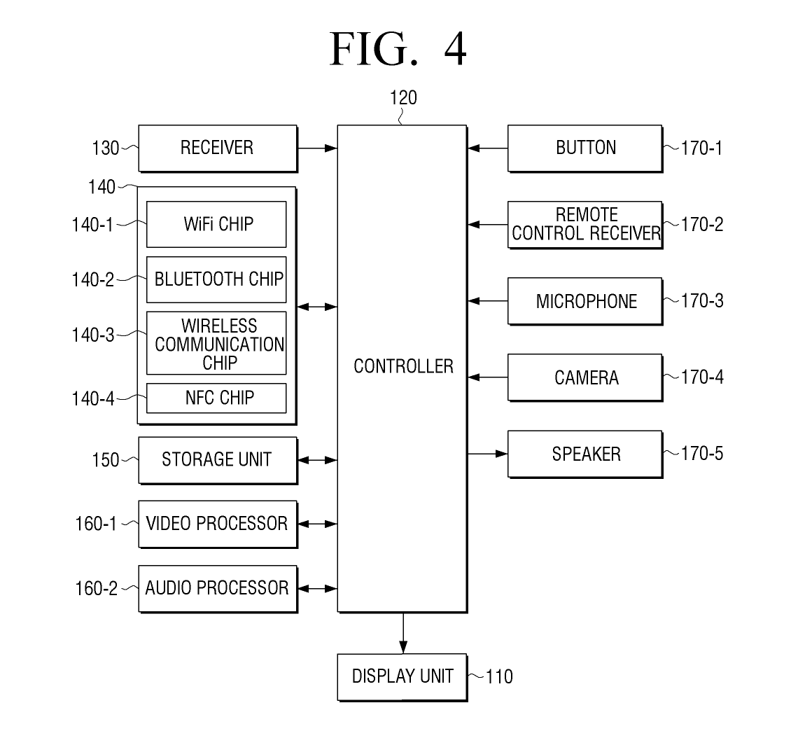

FIG. 4 is a block diagram illustrating the display apparatus 100 synthetically including various types of elements, according to an exemplary embodiment.

Referring to FIG. 4, display apparatus 100 may include display unit 110, controller 120, receiver 130, communicator 140, storage unit 150, video processor 160-1, audio processor 160-2, button 170-1, remote control receiver 170-2, microphone 170-3, camera 170-4, and speaker 170-5.

The display unit 110 may be realized as a general LCD display or a touch screen. If the display unit 110 is realized as a touch screen, a user may control an operation of the display apparatus 100.

The controller 120 controls an overall operation of the display apparatus 100 using various types of programs and data stored in storage unit 150. Display unit 110 and controller 120 have been described in detail in the above-described various exemplary embodiments, and thus their repeated descriptions are omitted herein.

The communicator 140 communicates with various types of external apparatuses according to various communication methods. The communicator 140 may include a WiFi chip 140-1, a Bluetooth chip 140-2, a wireless communication chip 140-3, and a Near Field Communication (NFC) chip 140-4.

The WiFi chip 140-1 and the Bluetooth chip 140-2 respectively perform communications by using a WiFi method and a Bluetooth method. If the WiFi chip 140-1 or the Bluetooth chip 140-2 is used, the WiFi chip 140-1 or the Bluetooth chip 140-2 may transmit and receive various types of connection information such as a Subsystem Identification (SSID), a session key, etc., perform communication connections by using the various types of connection information, and transmit the various types of information. The wireless communication chip 140-3 may communicate according to various communication standards such as IEEE, Zigbee, 3rd Generation (3G), 3rd Generation Partnership Project (3GPP), Long Term Evolution (LTE), etc. The NFC chip 140-4 may operate according to an NFC method using a 13.56 MHz band among various types of Radio Frequency Identification (RFID) frequency bands such as 135 KHz, 13.56 MHz, 433 MHz, 860 MHz to 960 MHz, 2.45 GHz, etc.

The communicator 140 may communicate with various types of external server apparatuses such as the search server 300. Therefore, the communicator 140 may transmit or receive various types of search words and receive search results related to the search words. The communicator 140 may directly communicate with various types of external apparatuses not with the server apparatuses to perform searches.

The video processor 160-1 processes video data included in content received through the communicator 140 or in content stored in the storage unit 150. In other words, video processor 160-1 may perform various types of image processing, such as decoding, scaling, noise filtering, a frame rate conversion, a resolution conversion, etc., with respect to the video data.

The audio processor 160-2 processes audio data included in content received through the communicator 140 or in content stored in the storage unit 150. The audio processor 160-2 may perform various types of processing, such as decoding, amplifying, noise filtering, etc., with respect to the audio data.

If a broadcasting program is received through the receiver 130, the controller 120 may control the video processor 160-1 and the audio processor 160-2 to multiplex the broadcasting program to respectively extract video data and audio data and to decode the extracted video data and audio data to play the corresponding broadcasting program. The display unit 110 may display an image frame generated by the video processor 160-1.

The speaker 170-5 may output audio data generated by the audio processor 160-2.

The button 170-1 may include various types of buttons, such as a mechanical button, a touch pad, a wheel, etc. formed in an arbitrary area of a front, a side, or a back of an outer part of a body of the display apparatus 100.

The remote control receiver 170-2 may receive a control signal from an external remote controller and transmit the control signal to the controller 120. In this case, like the button 170-1, the remote control receiver 170-2 may be formed in an arbitrary area of a front, a side, or a back of the outer part of the body of the display apparatus 100.

The microphone 170-3 receives a user voice or other sound and converts the user voice or other sound into audio data. The controller 120 may use the user voice input through the microphone 170-3 to extract a keyword or convert the user voice into audio data and store the audio data in the storage unit 150.

The camera 170-4 captures a still image or video according to user control. A plurality of cameras 170-4, such as a front camera, a back camera, etc., may be provided.

If camera 170-4 and microphone 170-3 are provided, controller 120 may perform a control operation according to the user voice input through the microphone 170-3 or a user motion recognized by the camera 170-4. In other words, the display apparatus 100 may operate in a motion control mode or a voice control mode. If the display apparatus 100 operates in a motion control mode, the controller 120 activates the camera 170-4 to capture the user and tracks a motion change of the user to perform a control operation corresponding to the motion change. If the display apparatus 100 operates in a voice control mode, the controller 120 may analyze the user voice input through the microphone and perform a control operation according to the analyzed user voice. Therefore, the camera 170-4 and the microphone 170-3 may be used to allow the controller 120 to recognize user motion or a user voice in order to extract a keyword.

According to the above-described various exemplary embodiments, a voice recognition technique or a motion recognition technique may be used in the display apparatus 100 supporting motion control mode or the voice control mode. For example, if a user makes a motion to select an object displayed on a screen or utters a voice command corresponding to the object, the controller 120 may determine that the corresponding object has been selected and perform a control operation matching with the object.

Although not shown in FIG. 4, display apparatus 100 may further include various types of input ports for connecting the display apparatus 100 to various types of external terminals, such as a Universal Serial Bus (USB) port to which a USB connector may be connected, a headset, a mouse, a LAN, etc., a Digital Multimedia Broadcasting (DMB) chip that receives and processes a DMB signal, etc.

As described above, the display apparatus 100 may be realized in various forms.

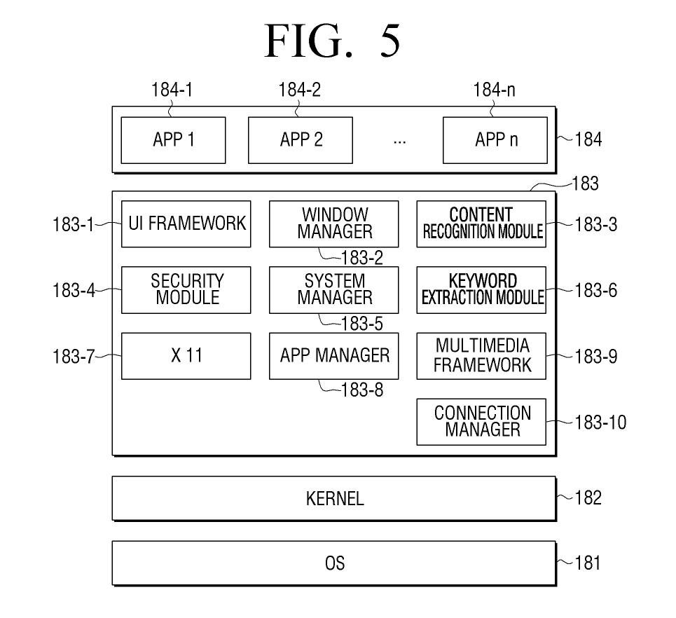

FIG. 5 is a block diagram illustrating a structure of software that is used by the display apparatus 100, according to an exemplary embodiment.

The software of FIG. 5 may be stored in the storage unit 150 but is not limited thereto. Therefore, the software of FIG. 5 may be stored in various types of storage units that are used in the display apparatus 100. Referring to FIG. 5, software including an OS 181, a kernel 182, middleware 183, an application 184, etc. may be stored in the display apparatus 100.

The OS 181 controls and manages an overall operation of hardware. In other words, the OS 181 is a layer that takes charge of basic functions such as hardware management and memory, security, etc.

The kernel 182 operates as a path through which various types of signals sensed by a sensor (not shown), etc. are transmitted to the middleware 183.

The middleware 183 may include various types of software modules that control an operation of the display apparatus 100. Referring to FIG. 5, the middleware 183 includes a User Interface (UI) framework 183-1, a window manager 183-2, a content recognition module 183-3, a security module 183-4, a system manager 183-5, a keyword extraction module 183-6, an X11 module 183-7, an APP manager 183-8, a multimedia framework 183-9, and a connection manager 183-10.

The UI framework 183-1 provides various types of UIs. The UI framework 183-1 may include an image compositor module that constitutes various types of objects, a coordinate compositor that calculates coordinates for the objects, a rendering module that renders the objects to the calculated coordinates, a 2D/3D UI toolkit that provides a tool for constituting a 2D or 3D UI, etc.

The window manager 183-2 may sense a touch event using, for example, a body of a user or a pen or other types of input events. If such an event is sensed, window manager 183-2 may transmit an event signal to the UI framework 183-1 to perform an operation corresponding to the event.

The content recognition module 183-3 recognizes content included in a signal received by the receiver 130 to extract information about the content. In more detail, the content recognition module 183-3 may extract detailed information such as a title, a broadcasting time, an actor or actress, broadcasting channel information, etc. of a broadcasting program included in a broadcasting signal.

The security module 183-4 supports a certification of hardware, a request permission, a secure storage, etc.

The system manager 183-5 monitors states of elements of the display apparatus 100 and provides a monitoring result to other modules. For example, if a residual battery amount is unavailable, an error occurs, or a communication is disconnected, system manager 183-5 may provide a monitoring result to the UI framework 183-1 to output a notification or sound.

Keyword extraction module 183-6 may extract a keyword associated with content from information of the content extracted by the content recognition module 183-3. For example, keyword extraction module 183-6 may search program guide information or various types of information pre-stored in the storage unit 150 for text related to the information extracted by the content recognition module 183-3 to extract the searched text as a keyword. For example, if the content recognition module 183-3 extracts the title, the broadcasting time, the actor or actress, the broadcasting channel information, etc. of the broadcasting program included in the broadcasting signal, the keyword extraction module 183-6 may extract the title of the broadcasting program, text including the title, name of the actor or actress, title of another program in which the same actor or actress appears, title of another program broadcasted through the same broadcasting channel, or the like as a keyword. The keyword extraction module 183-6 may extract a keyword candidate from the first search result received by the communicator 140.

The X11 module 183-7 receives various types of event signals from various types of hardware included in the display apparatus 100. Here, an event may be defined as an event in which a user control is sensed, an event in which a system alarm occurs, an event in which a particular program is executed or ended, or the like

The APP manager 183-8 may manage execution states of various types of applications installed in the storage unit 150. If an event is sensed in which an application execution command is input from the X11 module 183-7, the APP manager 183-8 may call and execute an application corresponding to the event. In other words, if an event is sensed in which at least one object is selected on a screen, the APP manager 183-8 may call and execute an application corresponding to the object.

The multimedia framework 183-9 may play multimedia content stored in the display apparatus 100 or provided from an external source. The multimedia framework 183-9 may include a player module, a camcorder module, a sound processing module, etc. Therefore, the multimedia framework 183-9 may play various types of multimedia contents by generating and presenting a visual element and audio.

The connector manager 183-10 supports a wire or wireless network connection. The connection manager 183-10 may include various types of detailed modules such as a DNET module, a UPnP module, etc.

The structure of the software of FIG. 5 is only an example but is not limited thereto. Therefore, some of the software may be omitted, changed, or added. The storage unit 150 may additionally include a sensing module for analyzing signals sensed by various types of sensors, a messaging module such as a messenger program, a Short Message Service (SMS) & Multimedia Message Service (MMS) program, an e-mail program, or the like, a call info aggregator program module, a VoIP module, a web browser module, etc.

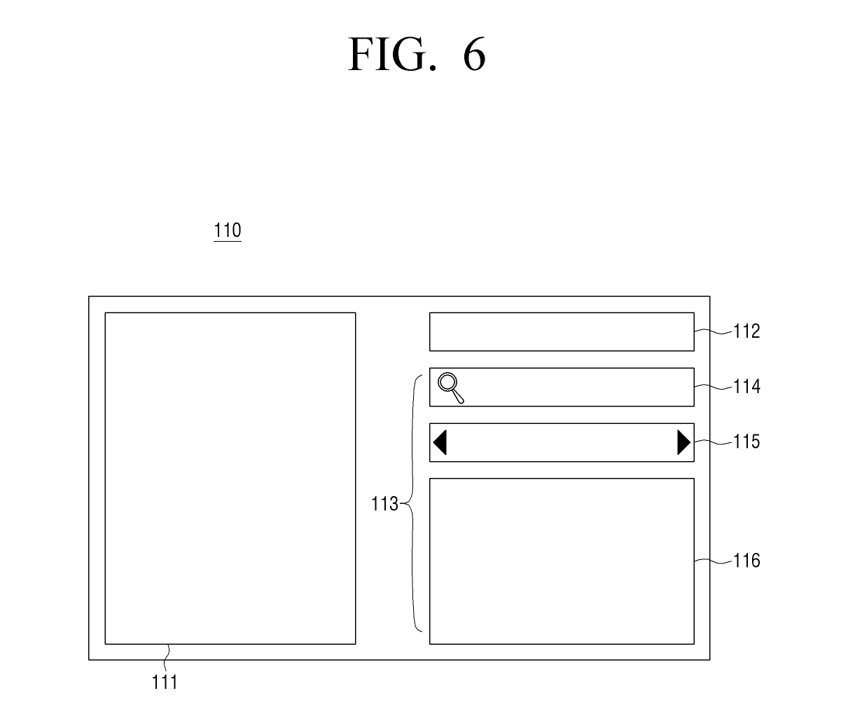

FIG. 6 is a view illustrating a structure of a screen of a display apparatus according to an exemplary embodiment.

Referring to FIG. 6, a screen may include a first area 111 and a search area 113.

The first area 111 may be an area in which a content is displayed. If a program information guide is supported, the program information guide may be displayed at a side of the first area 111.

The search area 113 may include a second area 115 for displaying a plurality of keyword candidates, a third area 114 for displaying a second keyword selected from the plurality of keyword candidates, and a fifth area 116 for displaying a content title and a search result of a first keyword. The second, third, and fifth areas 115, 114, 116 will be described in more detail later.

As shown in FIG. 6, the first area 111 and the search area 113 may refer to predetermined areas of the screen of the display apparatus and may be set by a user. Therefore, only the first area might be displayed according to a user setting, or only the search area 113 may be displayed according to a user setting. Also, the user may set positions, screen ratios, etc. of the first area 111 and the search area 113.

The screen may further include a fourth area 112 for displaying information about the search server 300. In other words, the fourth area 112 may display information of the search server 300 that transmits and receives a signal with the communicator 140. In this case, the fourth area 112 may display a name, a trademark, an icon, etc. of the search server 300.

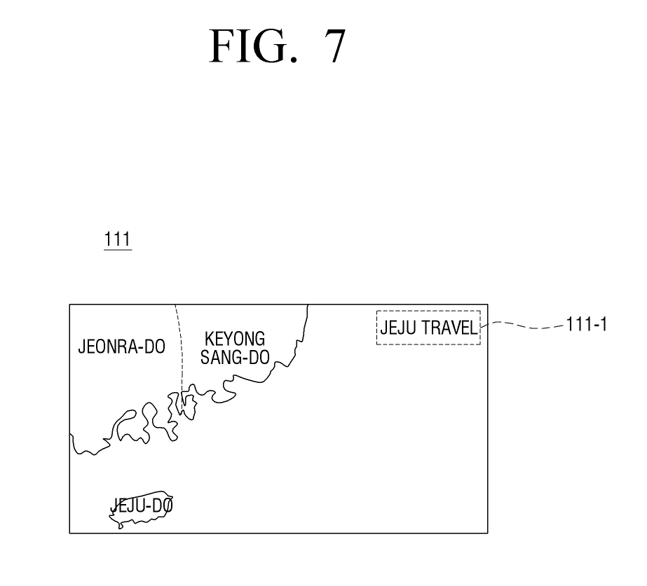

FIG. 7 is a view illustrating a detailed screen of the first area 111 of FIG. 6, according to an exemplary embodiment.

Referring to FIG. 7, content may be displayed in the first area 111. Here, if program guide information is supported, the first area 111 may include a content title display area 111-1 on a side of the first area 111. Therefore, a content title may be automatically displayed in the content title display area 111-1. In FIG. 7, currently displayed content is a documentary titled “Jeju Travel” and supports program guide information. Therefore, “Jeju Travel” may be automatically displayed in the content title display area 111-1. The content title display area 111-1 may optionally not be shown according to a user setting.

Therefore, the controller 120 may extract a first keyword of the content and transmit the extracted first keyword along with the content title to the search server 300. In this case, the controller 120 may control to display the first keyword, which is automatically extracted by the controller 120, in the content title display area 111-1. Here, a first keyword candidate of the first keyword is included in the program guide information and may be “Jeju-do”, “production company”, “production date”, “narrator”, “producer”, or the like. The first keyword selected from keywords of the content may be “Jeju-do”.

The first keyword candidate and the first keyword might not be displayed in the search area 113. In other words, when the first keyword candidate is not displayed in the first area 111 or the search area 113, the controller 120 may extract the first keyword. Therefore, when the extracted first keyword is not displayed in the first area 111 or the search area 113, the extracted first keyword may be transmitted to the search server 300 through the communicator 140.

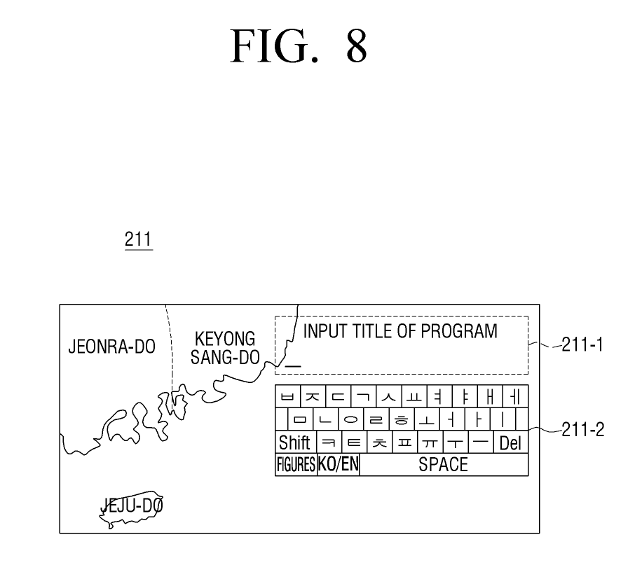

FIG. 8 is a view illustrating a detailed screen illustrating a first area of FIG. 6, according to an exemplary embodiment.

The program guide information is supported in the exemplary embodiment of FIG. 7 but is not supported in the exemplary embodiment of FIG. 8. In this case, a UI screen for inputting a content title and/or a first keyword from a user may be displayed through a display unit. Therefore, a content title input area 211-2 guiding a user to manually input the content title may be displayed on a side of the first area 211. If the user inputs the content title into the content title input area 211-2, the content title may be displayed in a content title display area 211-1. Therefore, in FIG. 8, a currently displayed content is a documentary titled “Jeju Travel”, and the user may directly input “Jeju Travel” into the content title display area 211-1. The user may also input the first keyword into the content title display area 211-1. The first keyword input by the user may be transmitted along with the content title to the search server 300. Here, the user may directly input the content title “Jeju Travel” and the first keyword “Jeju-do” together into the content title display area 211-1. Also, an additional first keyword input area (not shown) may be displayed, and the user may directly input the content title “Jeju Travel” into the content title display area 211-1 and the first keyword “Jeju-do” into the additional first keyword input area.

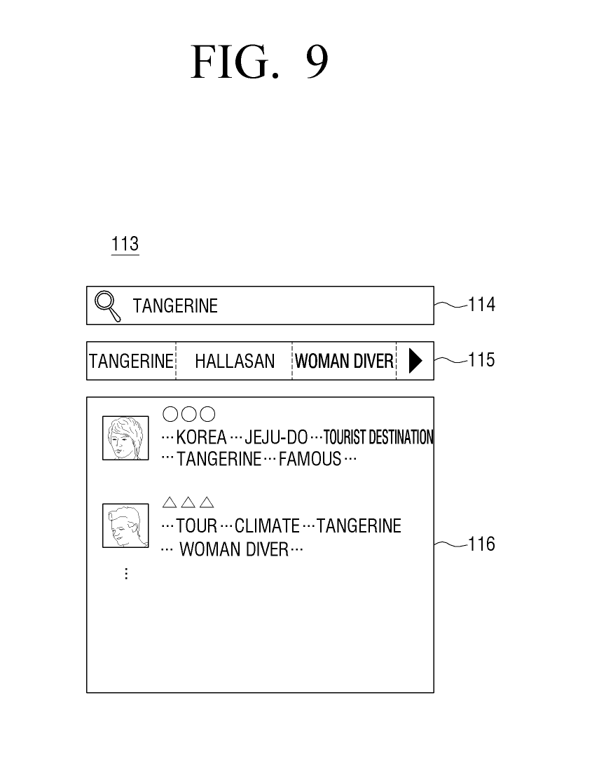

FIG. 9 is a view illustrating first results that are search results of a first keyword and a content title displayed on a detailed screen displaying a search area of FIG. 6, according to an exemplary embodiment.

As described with reference to FIGS. 7 and 8, in the display apparatus 100 according to one exemplary embodiment, the controller 120 may extract a content title “Jeju Travel” and a first keyword “Jeju-do”, and the communicator 140 may transmit the content title “Jeju Travel” and the first keyword “Jeju-do” to the search server 300. Therefore, the search server 300 that has received the content title and the first keyword may use “Jeju Travel” and “Jeju-do” as search words to perform a search. The search server 300 may transmit a first search result obtained by using the content title and the first keyword as search words, to the communicator 140. Therefore, referring to FIG. 9, a search result, which is obtained by using “Jeju Travel” and “Jeju-do” as the search words, may be displayed in the fifth area 116.

The first search result displayed in the fifth area 116 may include the content title and/or a first keyword that has been highlighted. In other words, the displayed first search result may be given an effect such as a change in color, increased font size, different font, glowing text, or the like of the content title and/or the first keyword, so that a user may easily check positions of the content title and/or the first keyword.

A first search result may include a plurality of words, and the plurality of words may be referred to as second keyword candidates. Therefore, the controller 120 may arrange and display the second keyword candidates in the second area 115.

In this case, the second keyword candidates displayed in the second area 115 may be arranged according to a frequency of the second keyword candidates for which many search requests are made to the search server 300. Therefore, if many search requests for keywords in the order of “Tangerine”, “Hallasan”, “Female Diver”, etc., are made with the search server 300, these keywords may be displayed in the second area 115 in order of “Tangerine”, “Hallasan”, “Woman Diver”, etc.

The second keyword candidates displayed in the second area 115 may be arranged in order of the second keyword candidates for which many search requests are made with respect to the search server 300 for a preset time. Therefore, if a keyword for which many search requests are made with respect to the search server 300 for 24 hours is “Woman Diver”, “Woman Diver” may be first displayed in the second area 115.

Also, the second keyword candidates displayed in the second area 115 may be arranged in order of the second keyword candidates that are included in the first search result a large number of times. Therefore, if keywords included in the first search result a large number of times are arranged in order of “Tangerine”, “Hallasan”, “Woman Diver”, etc., the keywords may be displayed in the second area 115 in the order of “Tangerine”, “Hallasan”, “Woman Diver”, etc.

A user may select one of the second keyword candidates displayed in the second area 115. A second keyword that is a keyword selected from the second keyword candidates may be displayed in the third area 114, and the communicator 140 may transmit the second keyword to the search server 300.

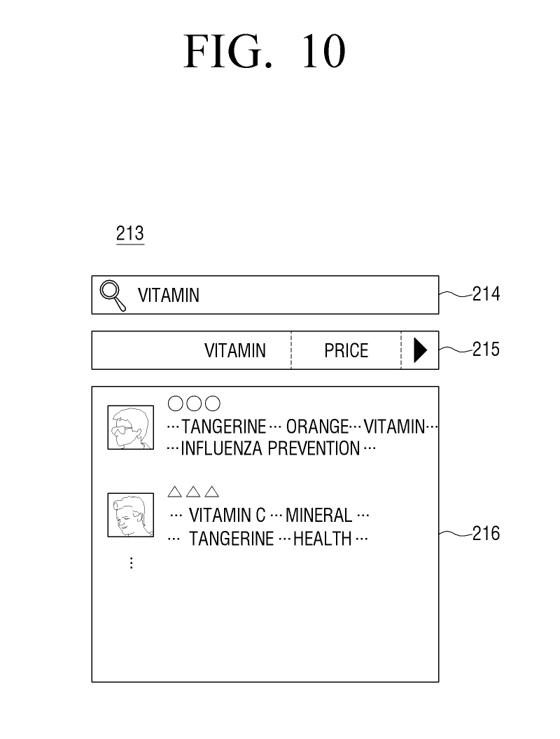

FIG. 10 is a view illustrating a second search result that is a result of a second keyword displayed on a detailed screen displaying a search area 213, similar to search area 113 of FIG. 6, according to another exemplary embodiment.

As described with reference to FIG. 9, the controller 120 may extract a second keyword “Tangerine”, and the communicator 140 may transmit the second keyword to the search server 300. Therefore, the search server 300 which received the second keyword may use “Tangerine” as a search word to perform a search. The search server 300 may transmit a second search result obtained by using the second keyword as the search word, to the communicator 140. Therefore, referring to FIG. 10, the second search result obtained by using “Tangerine” as the search word may be displayed in a fifth area 216.

The second search result displayed in the fifth area 216 may include the second keyword that has been highlighted. In other words, the displayed second search result may be given an effect such as a change in color, increased font size, different font, glowing text, or the like of the second keyword, so that a user may easily check a position of the second keyword.

Here, the second search result may include a plurality of words, and the plurality of words may be referred to as third keyword candidates. Therefore, the controller 120 may arrange and display the third keyword candidates in a second area 215.

In this case, the third keyword candidates displayed in the second area 215 may be arranged in order of third keyword candidates for which many search requests are made with respect to the search server 300 (e.g., frequency). This is the same as described with reference to FIG. 9. Therefore, if keywords for which many search requests are made with respect to the search server 300 are arranged in order of “Vitamin”, “Price”, etc., the keywords may be displayed in the second area 115 in order of “Vitamin”, “Price”, etc.

The third keyword candidates displayed in the second area 215 may be arranged in order of the third keyword candidates for which many search requests are made with respect to the search server 300 for a preset time. Therefore, if the keyword “Influenza Prevention” is the most frequent search request made to the search server 300 for the previous 50 hours, “Influenza Prevention” may be first displayed in the second area 215.

Also, the third keyword candidates displayed in the second area 215 may be arranged in order of the third keyword candidates included in the second search result a larger number of times (e.g., frequently). Therefore, if keywords that are included in the second search result a large number of times are displayed in order of “Vitamin”, “Price”, etc., the keywords may be displayed in the second area 215 in order of “Vitamin”, “Price”, etc.

A user may select one of the third keyword candidates displayed in the second area 215. A third keyword that is a keyword selected from the third keyword candidates may be displayed in a third area 214, and the communicator 140 may transmit the third keyword to the search server 300.

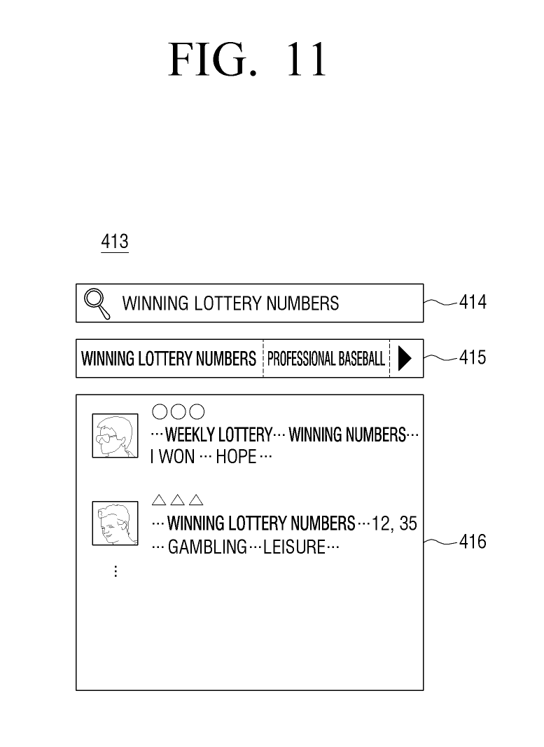

FIG. 11 is a view illustrating a detailed screen displaying a search area 413, similar to search area 113 of FIG. 6, according to another exemplary embodiment.

A display apparatus according to another exemplary embodiment may display a keyword candidate that is unrelated to a content. Referring to FIG. 11, a currently displayed content is a documentary titled “Jeju Travel”, but a keyword candidate unrelated to the currently displayed content may be displayed in a second area 415. In this case, keyword candidates displayed in the second area 415 may be displayed in order to search words for which search requests are currently the most frequently made to the search server 300. Therefore, if keywords for the most frequent search requests made to the search server 300 are displayed in order of “Winning Lottery Numbers”, “Professional Baseball”, etc., keyword candidates may be displayed in the second area 415 in order of “Winning Lottery Numbers”, “Professional Baseball”, etc.

A user may select a keyword that the user wants to search for, from the keyword candidates displayed in the second area 415. For example, if a user selects “Winning Lottery Numbers” as a keyword, “Winning Lottery Numbers” may be displayed in a third area 414. Also, the communicator 140 may transmit the selected keyword “Winning Lottery Numbers” to the search server 300, and the search server 300 may perform a search for “Winning Lottery Numbers” and transmit the search result to the communicator 140. Therefore, the search result of “Winning Lottery Numbers” may be displayed in a fifth area 416.

A search result displayed in the fifth area 416 may include a keyword that has been highlighted. In other words, the displayed search result may be given an effect such as a change in color, font size increase, different font, glowing text, or the like of the selected keyword, so that the user may easily check a position of the selected keyword.

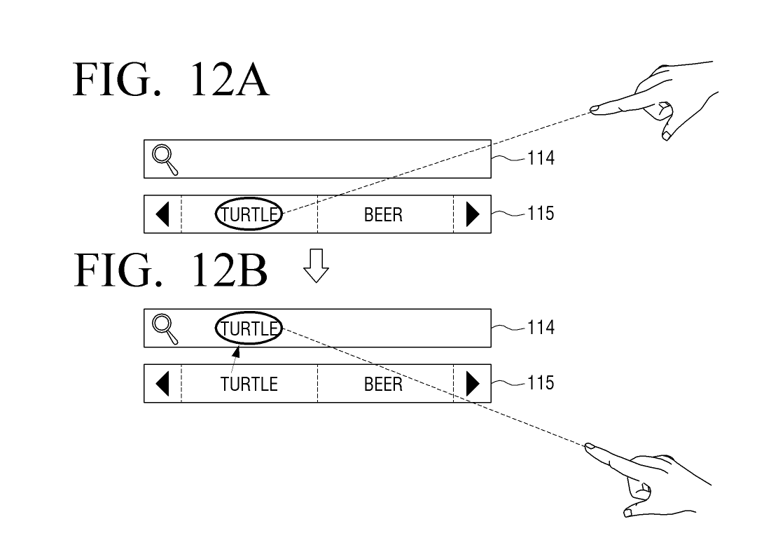

FIGS. 12 through 15 are views illustrating a processing of selecting a keyword according to various exemplary embodiments.

A user may extract a keyword from keyword candidates using a finger pointing method. Referring to FIG. 12A, keyword candidates are displayed in a second area 115. Using a finger, the user may point at a keyword that the user wants to search for from the displayed keyword candidates, and the controller 120 may recognize the pointing performed by the finger of the user. Also, the keyword pointed at by the finger of the user may be given an effect such as a change in color, increased font size, different font, glowing text, or the like under control of the controller 120. Therefore, if the user points at a keyword displayed in the second area with the finger to select the keyword, and the user moves a direction of the fingers toward the third area 114, the selected keyword may be displayed in the third area 114 as shown in FIG. 12B. A process of transmitting the selected keyword to the search server 300 and displaying a search result is as described above, and this its description is omitted herein.

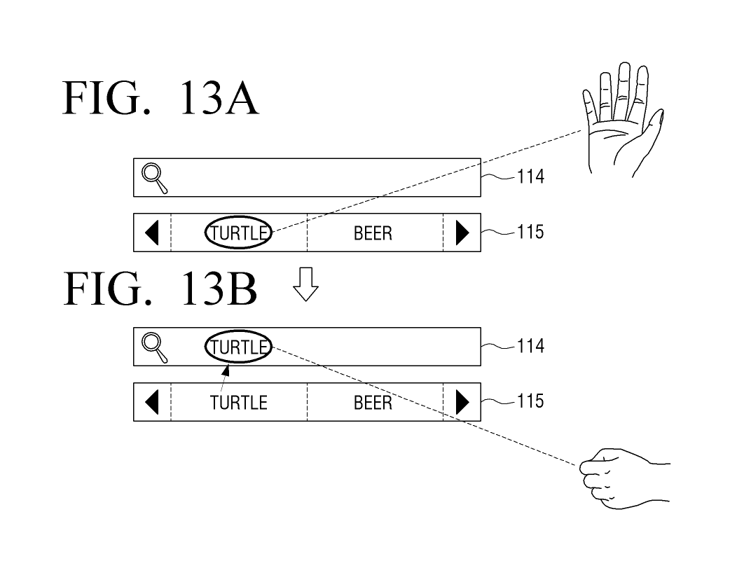

The user may extract a keyword from the keyword candidates using a grab and throw method. Referring to FIG. 13A, the keyword candidates are displayed in the second area 115. Using a palm, the user may point at a keyword that the user wants to search for from the displayed keywords, and the controller 120 may recognize the pointing performed by the palm of the user. Also, the keyword pointed by the palm of the user may be given an effect such as a change in color, increased font size, different font, glowing text, or the like under control of the controller 120. Therefore, when the user points at the keyword displayed in the second area with a palm and then clenches a fist, the keyword may be selected. If the user moves the first in a direction of the third area 114 and opens the fist, the selected keyword may be displayed in the third area 114 as shown in FIG. 13B.

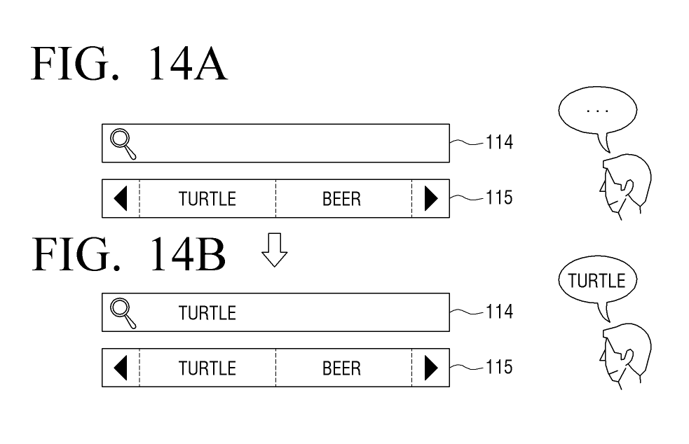

The user may extract the keyword from the keyword candidates using a voice recognition method. Referring to FIG. 14A, keyword candidates are displayed in the second area 115. The user may utter a keyword that the user wants to search for from the displayed keyword candidates, and the controller 120 may recognize a voice of the user. Therefore, if the user utters a keyword displayed in the second area 115, the uttered keyword is selected. Therefore, as shown in FIG. 14B, a selected keyword may be displayed in the third area 114.

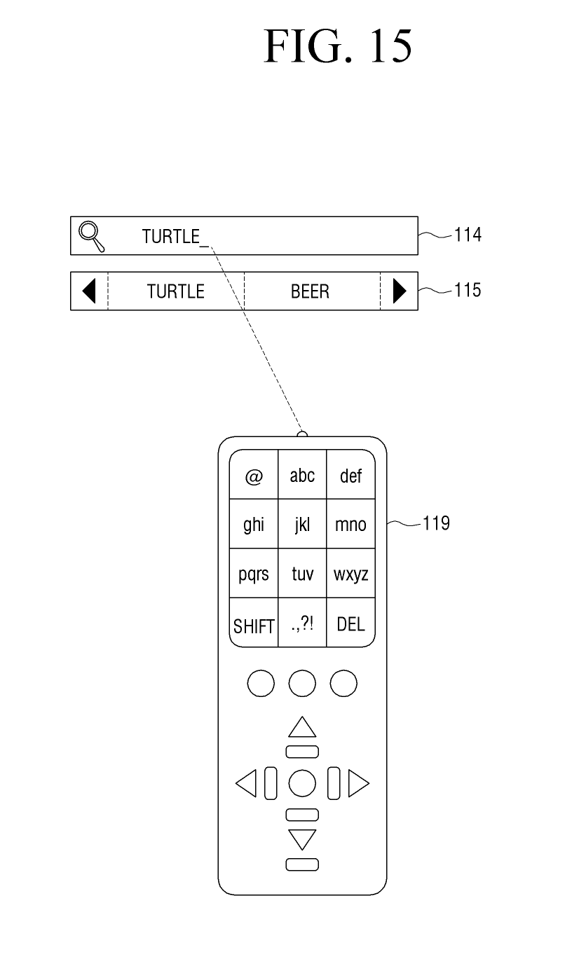

The user may extract a keyword from the keyword candidates through a remote controller 119. Referring to FIG. 15, keyword candidates are displayed in the second area 115. If a user directly inputs a keyword that the user wants to search for from the displayed keyword candidates through the remote controller 119, the selected keyword may be displayed in the third area 114 as shown in FIG. 15.

Also, a user may extract a keyword from the keyword candidates by using a keyword selection button (not shown) of the remote controller 119. In other words, the remote controller 119 may include a search mode button (not shown) and a keyword selection button. Therefore, a user may press a search mode button and then move the remote controller 119 toward a keyword that the user wants to select. In this case, a keyword position in a direction in which the remote controller 119 moves may be given various effects such as a change in color, increased font size, different font, glowing text, etc. If a keyword that a user wants to select is positioned in the direction in which the remote controller 119 moves, the user presses the keyword selection button and then moves the direction of the remote controller 119 toward the third area 114 to select the keyword. Therefore, the selected keyword may be displayed in the third area 114. If the user releases the keyword selection button, the search server 300 may perform a search for the selected keyword.

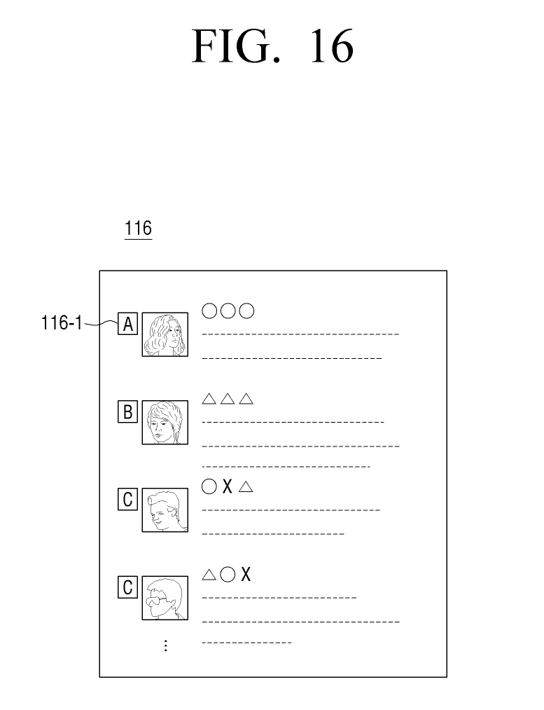

FIG. 16 is a view illustrating a detailed screen illustrating a fifth area of FIG. 6, according to another exemplary embodiment.

Referring to FIG. 16, search results of a keyword may be displayed in the fifth area 116. In particular, results of searches performed by one search server 300 may be displayed in the fifth area 116, or results of searches performed by a plurality of search servers 300 may be displayed in the fifth area 116.

If the search results performed by the plurality of search servers 300 are displayed in the fifth area 116, a search server display area 116-1 may be formed on a side of the fifth area 116 and display the search server 300 that has performed the corresponding search result. In this case, a name, a trademark, an icon, etc. of the search server 300 may be displayed in the search server display area 116-1. Therefore, as shown in FIG. 16, “A” is displayed in the search server display area 116-1 formed on a left side of a search result first displayed in the fifth area 116 to indicate that the first displayed search result is performed by a search server A. “B” is displayed in a search server display area formed on a left side of a search result secondly displayed in the fifth area 116 to indicate that the secondly displayed search result is performed by a search server “B”.

Search results may be displayed in the fifth area 116 according to a preset criterion. If the user sets the fifth area 116 to display the search results in order of time, the search results may be displayed in the fifth area 116 in order of the search results that have been most recently registered in the search server 300. Also, if the user sets the fifth area 116 to display the search results in order of reliability, the search results may be displayed in the fifth area 116 in orders of reliabilities evaluated by other users. In this case, if the search server 300 is an SNS, search results of a keyword may be displayed in the fifth area 116 in order of the search results that are fed back (for example, re-tweeted, liked, or the like) by another user a larger number of times

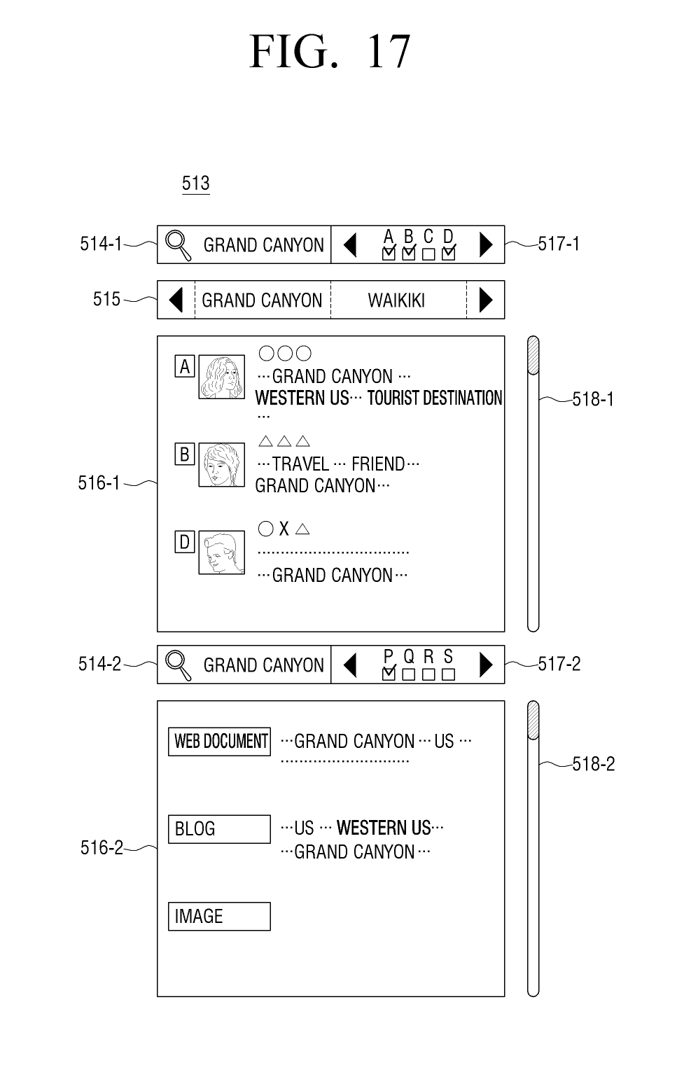

FIG. 17 is a view illustrating a detailed screen illustrating a search area of FIG. 6, according to another exemplary embodiment.

Referring to FIG. 17, a search area 513 may include a search area in which a search is performed through an SNS server and a search area in which a search is performed through a web server. In this case, although not shown in FIG. 17, the search server 300 may include at least one SNS server and at least one web server. The communicator 140 may transmit a content title and/or a keyword to the at least one SNS server and the at least one web server and receive a search result performed by the at least one SNS server and a search result performed by the at least one web server

The search area in which the search is performed through the SNS server includes a first area 514-1, an SNS server selection area 517-1, a second area 515, a third area 516-1, and a first scroll bar area 518-1. The first area 514-1, the second area 515, and the third area 516-1 are as described above, and the first scroll bar area 518-1 is a well-known technique, and thus their descriptions are omitted

The SNS server selection area 517-1 refers to an area in which a user selects at least one of a plurality of SNS servers transmitting search results to the communicator 140. If the SNS servers are “A”, “B”, “C”, and “D” as shown in FIG. 17, and the user wants to know search results of the SNS servers “A”, “B”, and “D” except the SNS server “C”, the user may de-select SNS server “C” and select the SNS servers “A”, “B”, and “D”. Therefore, search results of the SNS servers “A”, “B”, and “D” may be displayed in the third area 516-1. Means for selecting the SNS servers are displayed as check boxes in the SNS server selection area 517-1 in FIG. 7, but is not limited thereto.

The search area in which the search is performed through the web server includes a first area 514-2, a web server selection area 517-2, a third area 516-2, and a second scroll bar area 518-2. The first area 514-2 and the third area 516-2 are as described above, and the second scroll bar area 518-2 is a well-known technique, and thus their descriptions are omitted.

The web server selection area 517-2 refers to an area in which a user selects at least one of a plurality of web servers transmitting search results to the communicator 140, and its description is the same as that of the SNS server selection area 517-1.

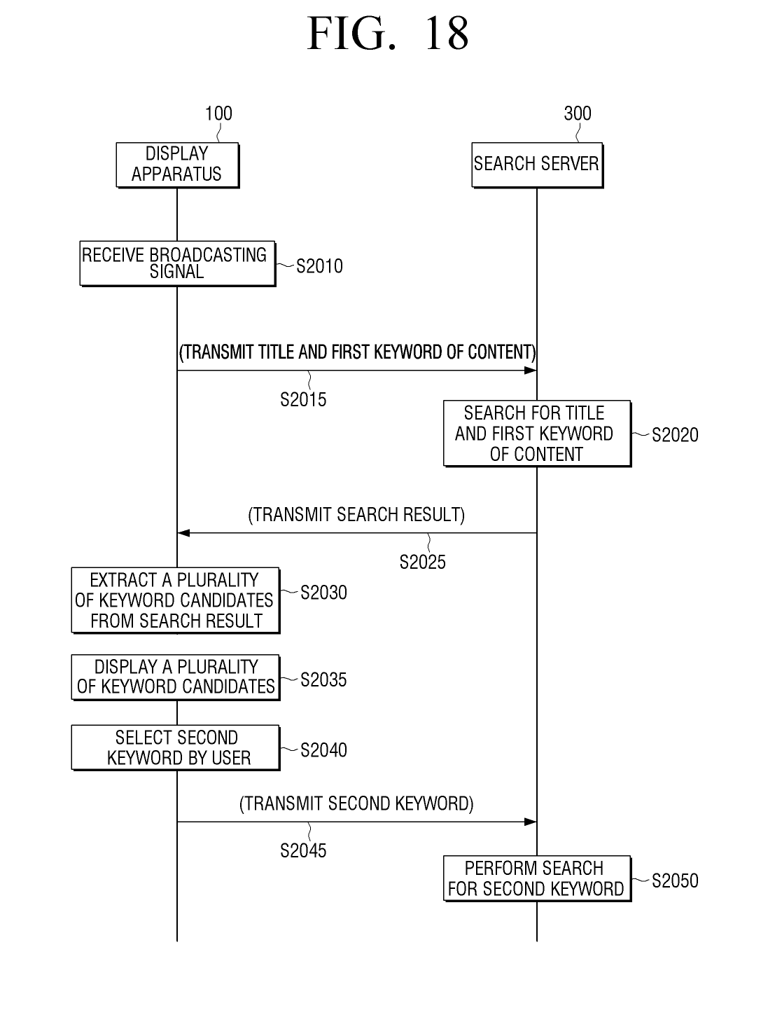

FIG. 18 is a flowchart illustrating a searching method according to an exemplary embodiment. The same descriptions of the present exemplary embodiment as those of the previous exemplary embodiments are omitted herein.

Referring to FIG. 18, a searching method according to the present exemplary embodiment includes: operation S2010 of receiving a broadcasting signal; operation S2015 of transmitting a first keyword and a content title included in the received broadcasting signal to a search server; operation S2025 of transmitting a search result performed based on the first keyword and the content title from the search server; operation S2030 of extracting a plurality of keyword candidates from the search result; operation S2035 of displaying the plurality of keyword candidates; operation S2040 of selecting a second keyword as one of the plurality of keyword candidates; operation S2045 of transmitting the second keyword to the search server; and operation S2050 of performs a search for the second keyword.

In operation S2010, a display apparatus 100 receives the broadcasting signal from a content providing server to receive the content. The received content may be displayed through the display apparatus 100. The received content may also include information about the content, and the information about the content may include a content title and at least one keyword of the content. The broadcasting signal has been described above but is not limited thereto.

After operation S2010, the searching method may further include: extracting a first keyword and the content title included in content information. If the display apparatus 100 supports program guide information, the first keyword and the content title may be automatically extracted.

However, if the display apparatus 100 does not support the program guide information, a user may input the first keyword and the content title. In this case, the display apparatus 100 may display a UI screen for receiving the title and the first keyword of the content from the user, and the user may input the title and the first keyword of the content through the displayed UI screen. Therefore, the title and the first keyword of the content may be extracted.

In operation S2015, the display apparatus 100 may transmit the title and the first keyword of the content to a search server 300. In operation S2020, the search server 300 that has received the title and the first keyword of the content may perform a search for the title and the first keyword of the content. In this case, the search server 300 may include at least one SNS server and at least one web server, and the search for the title and the first keyword of the content may be performed by the at least one SNS server and the at least one web server.

In operation S2025, the search server 300 may transmit a first search result, which is a search result of the title and the first keyword of the content, to the display apparatus 100. Therefore, the search server 300 may transmit a search result corresponding to the title and the first keyword of the content among SNS information registered (e.g., stored) in the at least one SNS server to the display apparatus 100. The search server 300 may also transmit a search result corresponding to the title and the first keyword of the content among information registered in the at least one web server to the display apparatus 100.

In operation S2030, the display apparatus 100 may extract keyword candidates from the first search result received from the search server 300. A plurality of keyword candidates may be extracted to select a second keyword and thus may be referred to as second keyword candidates.

In this case, the display apparatus 100 may display the first search result. The displayed first search result may be give an effect such as changed color, increased font size, different font, glowing text, or the like, of the title and/or the first keyword of the content, so that the user may easily check a position of the title and/or the first keyword of the content.

The second keyword candidates may be included in a first search result and may be displayed in operation S2035. In this case, second keyword candidates may be displayed according to a preset criterion. Therefore, the second keyword candidates may be arranged and displayed in order of the second keyword candidates that are most frequently included in the first search result or in order of the second keyword candidates for which search requests of at least another user have been recently received.

In operation S2040, the user may select the second keyword from the displayed second keyword candidates. In this case, the user may select the second keyword by using a finger pointing method, a grab and throw method, a user voice recognition method, and/or a remote controller method.

If a second keyword is selected by the user, the display apparatus 100 may transmit the selected second keyword to the search server 300 in operation S2045. In operation S2050, the search server 300 that has received the second keyword from the display apparatus 100 may perform a search for the second keyword.

The search server 300 may transmit a second search result, which is a search result of the second keyword, to the display apparatus 100, and the display apparatus 100 receiving the second search result from the search server 300 may display the second search result. In this case, the display apparatus 100 may display the content along with the second search result.

A display apparatus 100 screen may include a first area and a search area. The first area refers to an area in which the content may be displayed, and if program guide information is supported, program guide information may be displayed on a side of the first area. The search area includes a second area in which a plurality of keyword candidates may be displayed, a third area in which a keyword selected from a plurality of keyword candidates may be displayed, and a fifth area in which a search result of the keyword may be displayed. The search area may further include a fourth area in which information about the search server 300 may be displayed. The first through fifth areas are as described above, and thus their descriptions are omitted.

According to various exemplary embodiments described above, detailed information about content and other information related to the detailed information may be provided to a user. Therefore, convenience to the user may be improved.

A display apparatus and a searching method according to the above-described various exemplary embodiments may be embodied as a program and then provided to the display apparatus.

For example, a non-transitory computer-readable medium may store a program that performs a structure for calculating coordinate data according to a dragging trajectory if a position touched on a touch pad is dragged and transmitting the calculated coordinate data to the display apparatus. The non-transitory computer-readable medium may be provided to an input apparatus.

The non-transitory computer-readable medium refers to a medium which does not store data for a short time such as a register, a cache memory, a memory, or the like but semi-permanently stores data and is readable by a device. In detail, the above-described applications or programs may be stored and provided on a non-transitory computer readable medium such as a Compact Disc (CD), a Digital Versatile Disc (DVD), a hard disk, a blue-ray disk, a USB drive, a memory card, a ROM, or the like.

The foregoing exemplary embodiments and advantages are merely exemplary and are not to be construed as limiting. The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a receiver configured to receive a broadcasting signal;
a display configured to display content of the received broadcasting signal;
a communicator configured to transmit a first keyword and a content title and to receive a first search result based on the first keyword and the content title; and
a controller configured to extract a plurality of keyword candidates from the first search result, display the plurality of keyword candidates on the display, and if a second keyword is selected as one of the plurality of keyword candidates, to transmit the second keyword through the communicator to perform a search for the second keyword.

2. The display apparatus of claim 1, wherein the controller controls the communicator to automatically extract the first keyword and the content title based on program guide information of the broadcasting signal and to transmit the extracted first keyword and content title.

3. The display apparatus of claim 1, wherein the controller controls the communicator to display a user interface (UI) screen for receiving the first keyword and the content title through the display and, if the first keyword and the content title are received through the UI screen, to transmit the first keyword and the content title.

4. The display apparatus of claim 1, wherein if a second search result of the second keyword is received, the controller displays a screen comprising the second search result and the content on the display,
wherein the screen comprises a first area configured to display the content, a second area configured to display the plurality of keyword candidates, a third area configured to display the second keyword selected from the plurality of keyword candidates, a fourth area configured to display information about a search server, and a fifth area configured to display a result of a second search.

5. The display apparatus of claim 4, wherein the controller arranges and displays the plurality of keyword candidates in the second area according to a frequency of the plurality of keyword candidates in the first search result.

6. The display apparatus of claim 4, wherein the controller arranges and displays the plurality of keyword candidates in the second area according to a frequency of the plurality of keyword candidates for which search requests are made.

7. The display apparatus of claim 1, wherein the first search result is received from a search server, the search server being a Social Networking Service (SNS) server,
wherein the controller receives a second search result corresponding to the second keyword among SNS information registered in the SNS server and displays the second search result through the display.

8. A search method of a display apparatus, the searching method comprising:
receiving a broadcasting signal;
transmitting a first keyword and a content title of the received broadcasting signal;
if a first search result generated based on the transmitted first keyword and content title is received, extracting a plurality of keyword candidates from the first search result;
displaying the plurality of keyword candidates; and
if a second keyword is selected as one of the plurality of keyword candidates, transmitting the second keyword in order to perform a search for the second keyword.

9. The searching method of claim 8, wherein the transmitting of the first keyword and the content title comprises:
automatically extracting the first keyword and the content title based on program guide information of the broadcasting signal; and
transmitting the extracted first keyword and content title.

10. The searching method of claim 8, wherein the transmitting of the first keyword and the content title comprises:
displaying a user interface (UI) screen for receiving the first keyword and the content title; and
if the first keyword and the content title are input through the UI screen, transmitting the first keyword and the content title.

11. The searching method of claim 8, further comprising:
if a second search result of the second keyword is received, displaying a screen comprising the second search result and the content,
wherein the screen comprises a first area configured to display the content, a second area configured to display the plurality of keyword candidates, a third area configured to display the second keyword selected from the plurality of keyword candidates, a fourth area configured to display information about a search server, and a fifth area configured to display the second search result of the second keyword.

12. The searching method of claim 11, wherein the plurality of keyword candidates are arranged and displayed in the second area according to a frequency of the plurality of keyword candidates in the first search result.

13. The searching method of claim 11, wherein the plurality of keyword candidates are arranged and displayed in the second area according to a frequency of the plurality of keyword candidates for which search requests are made.

14. The searching method of claim 8, wherein the first search result is received from a search server, the search server being a Social Networking Service (SNS) server,
wherein the searching method further comprises: receiving and displaying a second search result corresponding to the second keyword among SNS information registered in the SNS server.

15. A display apparatus comprising:
a receiver configured to receive a broadcasting signal;
a display configured to display content of the received broadcasting signal;
a communicator configured to transmit a first keyword and a content title and to receive a first search result based on the first keyword and the content title; and
a controller configured to extract a plurality of keyword candidates from the first search result and display the plurality of keyword candidates on the display, to recognize an event and extract a keyword from the plurality of keyword candidates based on the recognized event, to select the extracted keyword as a second keyword, and to transmit the second keyword in order to perform a search for the second keyword.

16. The display apparatus of claim 15, wherein the controller is further configured to detect a finger gesture of a user as an event used to indicate the second keyword.

17. The display apparatus of claim 15, wherein the controller is further configured to detect a palm gesture of a user as an event used to indicate a grab and throw operation.

18. The display apparatus of claim 15, wherein the controller is further configured to detect audio of a user as an event used to indicate the second keyword.

19. A search method of a display apparatus, the search method comprising:
receiving a broadcasting signal;
transmitting a first keyword and a content title of the received broadcasting signal;
if a first search result generated based on the transmitted first keyword and content title is received, extracting a plurality of keyword candidates from the first search result;
displaying the plurality of keyword candidates;
recognizing an event corresponding to a selection of a second keyword from among the plurality of keyword candidates; and
transmitting the second keyword in order to perform a search for the second keyword.

20. The search method of claim 19, wherein the recognizing further comprises:
detecting a finger gesture of a user as the event corresponding to a selection of a second keyword.

21. The search method of claim 19, wherein the recognizing further comprises:
detecting a palm gesture of a user as the event used to indicate a grab and throw operation.

22. The search method of claim 19, wherein the recognizing further comprises:
detecting audio of a user as the event corresponding to a selection of a second keyword.
